(19) United States
(12) Patent Application Publication
(10) Pub. No.: US 2005/0158525 A1
(43) Pub. Date: Jul. 21, 2005

(54) Method and sheet of packing material for producing a packet, and packet so produced

(75) Inventors: Alessandro Brizzi, Crespellano (IT); Alessandro Minarelli, Bazzano (IT)

Correspondence Address: MARSHALL, GERSTEIN & BORUN LLP, 233 S. WACKER DRIVE, SUITE 6300, SEARS TOWER, CHICAGO, IL, 60606, US

(73) Assignee: G.D SOCIETA' PER AZIONI, Bologna (IT)

(21) Appl. No.: 11/035,528

(22) Filed: Jan. 14, 2005

(30) Foreign Application Priority Data
Jan. 20, 2004 (IT) BO2004A 000021

(51) Int. Cl. B32B 1/00

(52) U.S. Cl. 428/195.1

(57) ABSTRACT

A method and sheet of packing material for producing a packet, in particular a packet of cigarettes; a first and a second component of a bicomponent glue are deposited on at least two different portions of the sheet of packing material; and the sheet of packing material is then folded about an inner packet, containing a group of cigarettes, so that, during folding, the first and second component are brought into contact with each other to activate the bicomponent glue.

The present invention relates to a method and a sheet of packing material for producing a packet, and to the packet so produced.

The present invention may be used to advantage for packing cigarettes, to which the following description refers purely by way of example.

### BACKGROUND OF THE INVENTION

In cigarette packing, a “solvent” glue (e.g. glue with a vinyl resin base) is deposited on certain areas of a sheet of packing material; and the sheet of packing material is folded about a group of cigarettes to form a packet of cigarettes, which is stabilized in its finished form by the adhesive action of the glue.

Once applied, “solvent” glue remains active for a relatively short time, so must be used with considerable care. In packet production, a gumming device must therefore be located immediately upstream from a folding device to enable the sheet of packing material to be folded, and the glue to do its work, before the glue dries by evaporation of the solvent.

Such structural limitations obviously have a negative effect on the simplicity, cost, and flexibility of a machine for producing packets of cigarettes. Moreover, in the event of machine stoppages, even of only a few seconds, the sheets of packing material, to which glue has already been applied and which have not yet been folded correctly, must be rejected together with the respective groups of cigarettes, thus greatly increasing production cost through waste.

In cigarette packing, hot-melt glue is also known to be applied to certain areas of a sheet of packing material; the sheet of packing material is folded about a group of cigarettes; and the glue is then melted by bringing heating plates into contact with the outer surface of the sheet of packing material, at the areas to which glue has been applied.

When melting the glue, the cigarettes inside the packets, as well as certain areas of the sheet of packing material (particularly printed areas), may be damaged by direct contact between the heating plates and the sheet of packing material; and the heating plates also have a negative effect on the simplicity, cost, and easy handling of machines for producing packets of cigarettes.

In cigarette packing, the same heat-melt problems also apply to sheets of packing material defined by inland revenue stamps, collars, and coupons.

### SUMMARY OF THE INVENTION

It is an object of the present invention to provide a method of producing a packet, designed to eliminate the aforementioned drawbacks, and which at the same time is cheap and easy to implement.

According to the present invention, there is provided a method of producing a packet using a sheet of packing material; the method being characterized in that the sheet of packing material comprises at least one first portion having a first component of a bicomponent glue; and the method comprising a contact step to bring a second component of the bicomponent glue into contact with said first component, so as to activate the bicomponent glue; the first and the second component interacting to activate the bicomponent glue.

According to the present invention, there is also provided a sheet of packing material for producing a packet; the sheet of packing material being characterized by comprising a first portion having a first component of a bicomponent glue.

### BRIEF DESCRIPTION OF THE DRAWINGS

A number of non-limiting embodiments of the present invention will be described by way of example with reference to the accompanying drawings, in which:

FIG. 1 shows a schematic view in perspective of a detail of a machine for producing a packet of cigarettes and implementing a method in accordance with the present invention;

FIGS. 2 to 5 show steps in the manufacture of a packet of cigarettes by the FIG. 1 machine;

FIG. 6 shows a packet produced by the FIG. 1 machine;

FIG. 7 shows a sheet of packing material in accordance with a further embodiment of the present invention;

FIG. 8 shows a packet produced using the sheet of packing material in FIG. 7.

### DETAILED DESCRIPTION OF THE INVENTION

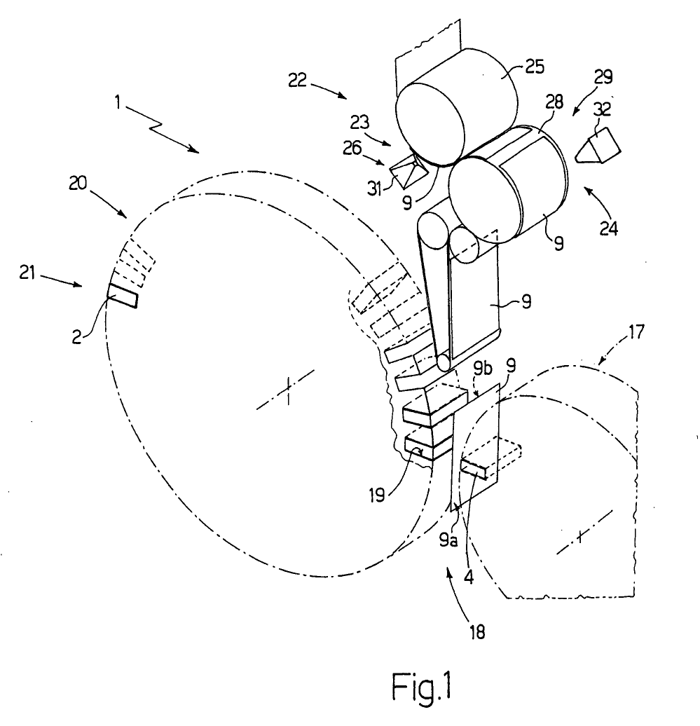

Number 1 in FIG. 1 indicates as a whole a machine for producing a “soft” packet 2 of cigarettes.

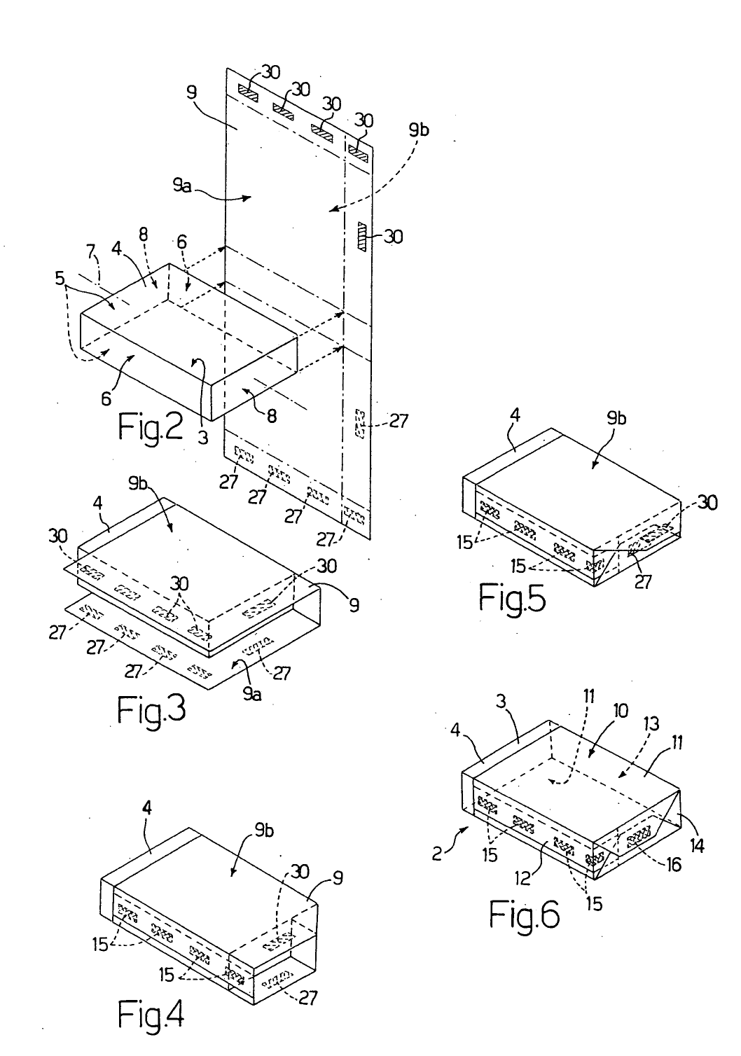

Packet 2 (FIG. 6) comprises a foil wrapping 3 enclosing a known group of cigarettes (not shown) to define an inner packet 4. As shown more clearly in FIG. 2, inner packet 4 is substantially in the shape of a rectangular parallelepiped, and comprises two parallel major lateral surfaces 5, two parallel minor lateral surfaces 6 perpendicular to lateral surfaces 5, a longitudinal axis 7 parallel to lateral surfaces 5 and 6, and two end surfaces 8 perpendicular to axis 7.

With reference to FIGS. 2 and 6, packet 2 also comprises a sheet of packing material 9, which is folded to define a folded wrapping 10 partly enclosing inner packet 4. Wrapping 10 is substantially cup-shaped, and comprises two major lateral walls 11 covering lateral surfaces 5 of inner packet 4; two minor lateral walls 12, 13 covering lateral surfaces 6 of inner packet 4; and an end wall 14 superimposed on one of end surfaces 8 of inner packet 4. Wrapping 10 is stabilized by a number of gummed portions 15 on lateral wall 12, and by a gummed portion 16 on end wall 14; which gummed portions 15 and 16 comprise an activated bicomponent glue.

As shown clearly in FIGS. 2 to 6, the sheet of packing material 9 has an inner surface 9a which contacts wrapping 3; and an outer surface 9b which defines packet 2 externally once the sheet of packing material 9 is folded about inner packet 4.

With reference to FIG. 1, machine 1 comprises a known conveyor wheel 17 (shown schematically) for feeding inner packet 4 to a transfer station 18 where known push members (not shown) transfer inner packet 4 to a seat 19 on a known folding wheel 20 (shown schematically). Folding wheel 20 receives inner packet 4 together with the respective sheet of packing material 9 at transfer station 18, folds the sheet of packing material 9 about inner packet 4 to form packet 2, and feeds packet 2 to an output station 21.

Machine 1 also comprises a feed unit 22 for feeding the sheet of packing material 9 to transfer station 18 via two gumming stations 23 and 24. Feed unit 22 comprises a conveyor roller 25 for feeding the sheet of packing material 9 through gumming station 23, where a gumming device 26 deposits a first component of the bicomponent glue on portions 27 (FIG. 2) of outer surface 9b of the sheet of packing material 9. Feed unit 22 also comprises a further conveyor roller 28 for feeding the sheet of packing material 9 through gumming station 24, where a gumming device 29 deposits a second component of the bicomponent glue on portions 30 (FIG. 2) of inner surface 9a of the sheet of packing material 9.

Gumming devices 26, 29 each comprise a respective applicator 31, 32 (e.g. a spray or coating device) for applying the respective component of the bicomponent glue to the sheet of packing material 9.

In actual use, on reaching transfer station 18, the sheet of packing material 9 is intercepted by inner packet 4, as inner packet 4 is transferred from conveyor wheel 17 to seat 19 on folding wheel 20; and inner packet 4 takes the sheet of packing material 9 with it, and folds it into a U (FIG. 3) inside seat 19.

FIGS. 2 to 5 show the sequence in which the sheet of packing material 9 is folded about inner packet 4, while inner packet 4 and the sheet of packing material 9 are inside seat 19. It is important to note, as shown clearly in the drawings, that the sheet of packing material 9 is folded about inner packet 4 so as to superimpose portions 27 and 30 and define gummed portions 15 and 16. The first and second component of the bicomponent glue are thus brought into contact, and interact to activate the bicomponent glue, which thus performs its adhesive function to stabilize packet 2.

In the alternative embodiment in FIG. 7, the first component of the bicomponent glue is deposited on portions 33 of inner surface 9a of the sheet of packing material 9; and the second component of the bicomponent glue is deposited on portions 34 of inner surface 9a. Portions 33 are substantially adjacent to portions 34, so that, when the first and second component are subjected to pressure at the folding step, the first and second component are spread on inner surface 9a into contact with each other to activate the bicomponent glue.

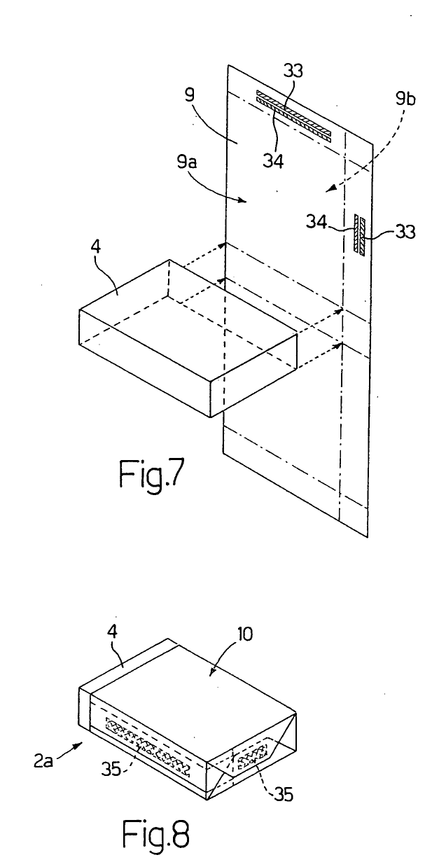

FIG. 8 shows the packet 2a produced using the sheet of packing material 9 in FIG. 7, and which is stabilized by gummed portions 35 of activated bicomponent glue.

Preferably, the first component of the bicomponent glue (e.g. an epoxy resin) comprises a group of monomers (e.g. epoxy molecules); and the second component of the bicomponent glue comprises a catalyst for catalyzing polymerization of the monomers.

In further embodiments, in addition to or instead of the catalyst, the second component comprises further compounds (e.g. polyamines) for cross-linking the polymer chains produced by polymerizing the monomers of the first component.

In further alternative embodiments, the first component comprises the catalyst, and the second component the group of monomers.

In preferred embodiments, the monomers are chosen and treated so as to be polymerizable for at least ten minutes after they are applied to the sheet of packing material 9; the monomers and the catalyst are chosen and treated so that polymerization, i.e. activation of the bicomponent glue, is completed within forty seconds at ambient temperature after the two components come into contact; and the monomers and/or the catalyst are applied to the sheet of packing material in the form of a solution comprising water.

It is important to note that gumming stations 23 and 24 may therefore be located some distance from folding wheel 20, and that, in the event of stoppage of machine 1, the sheet of packing material 9 to which the two components of the bicomponent glue have been applied need not, in most cases, be rejected.

In further embodiments not shown, both (or only one) of the two components of the bicomponent glue may be applied to the sheet of packing material 9 at a remote location (e.g. the paper factory), so as to feed machine 1 with a sheet of packing material 9 requiring no gumming or activation by operating units on machine 1, which is thus simpler, cheaper, and easier to handle.

In an embodiment not shown, both components of the bicomponent glue are applied to the same portions of the sheet of packing material 9 by respective spray devices or applicator rollers; in which case, the glue is activated before the sheet of packing material 9 is folded, and there is no need for complex, high-cost heating plates by which to activate the glue.

This embodiment therefore also provides for reducing the cost and complexity of machine 1.

Though the above description and attached drawings relate to manufacture of a “soft” packet of cigarettes, the teachings of the present invention obviously apply to the manufacture of any type of packet, in particular packets of cigarettes, such as conventional hinged-lid packets with rounded or bevelled edges; in which case the sheet of packing material 9 is defined by a sheet of rigid cardboard, and is provided with preformed fold lines.

The teachings of the present invention may obviously also be applied to advantage when the sheet of packing material 9 is defined by a collar, an inland revenue stamp, or a coupon. In which case, the two components of the bicomponent glue may be deposited on two adjacent but separate areas of a coupon (inland revenue stamp or collar) before the coupon is applied to a blank for packing a group of cigarettes; and the two components spread into contact with each other when the coupon is applied. A coupon (inland revenue stamp or collar) and a blank may also be provided with respective components of the bicomponent glue, so that the components are superimposed one on top of the other when the coupon is applied. The two components of the bicomponent glue may also be deposited on two adjacent but separate areas of a blank, and a coupon (inland revenue stamp or collar) may be applied to said areas so that the two components spread into contact with each other.

1) A method of producing a packet using a sheet of packing material (9); the method being characterized in that the sheet of packing material (9) comprises at least one first portion (27) having a first component of a bicomponent glue; and the method comprising a contact step to bring a second component of the bicomponent glue into contact with said first component, so as to activate the bicomponent glue; the first and the second component interacting to activate the bicomponent glue.

2) A method as claimed in claim 1, wherein, at the contact step, said second component is deposited on said first component.

3) A method as claimed in claim 2, wherein the second component is deposited on the first component by means of a spray device.

4) A method as claimed in claim 2, wherein the second component is deposited on the first component by means of an applicator roller.

5) A method as claimed in claim 1, and comprising an application step to deposit the second component on at least one second portion (30) of the sheet of packing material (9); the first and the second portion (27, 30) being two separate portions (27, 30) of the sheet of packing material (9).

6) A method as claimed in claim 1, wherein the sheet of packing material (9) comprises at least one second portion (30) having the second component; the first and the second portion (27, 30) being two separate portions of the sheet of packing material (30).

7) A method as claimed in claim 5, and comprising a folding step to fold the sheet of packing material (9) to form a folded wrapping (10) in which, during the folding step, said first and said second portion (27, 30) are superimposed to bring said first and said second component into contact with each other.

8) A method as claimed in claim 5, wherein the first and second portion (27, 30) are located on the same surface (9a) of the sheet of packing material and substantially adjacent to each other; the first and second component being subjected to pressure, so that the first and second component spread on said surface (9a) into contact with each other.

9) A method as claimed in claim 1, wherein said first component comprises a substance selected from a group comprising:
a group of monomers, and
a catalyst for catalyzing polymerization of said monomers;
the second component being selected from a group comprising:
a group of monomers, and
a catalyst for catalyzing polymerization of said monomers;
on condition that: if the first component comprises the group of monomers, the second component comprises said catalyst; and, if the first component comprises the catalyst, the second component comprises said group of monomers.

10) A method as claimed in claim 9, wherein the monomers are selected and treated so as to be polymerizable for at least ten minutes after they are applied to the sheet of packing material (9).

11) A method as claimed in claim 9, wherein the monomers and the catalyst are selected and treated so that polymerization, i.e. activation of the bicomponent glue, is completed within forty seconds at ambient temperature after the first and second component come into contact with each other.

12) A method as claimed in claim 9, wherein the monomers and/or the catalyst are applied to the sheet of packing material (9) in the form of a solution comprising water.

13) A method as claimed in claim 1, and comprising a folding step to fold the sheet of packing material (9) to form a folded wrapping (10).

14) A sheet of packing material for producing a packet; the sheet of packing material (9) being characterized by comprising a first portion (27) having a first component of a bicomponent glue.

15) A sheet of packing material as claimed in claim 14, and comprising a second portion (30) having a second component of the bicomponent glue; the first and second portion being two separate portions of the sheet of packing material (9); and the first and second component interacting to activate the bicomponent glue.

16) A sheet of packing material as claimed in claim 15, wherein the first and second portion (27, 30) are substantially adjacent, so that, when, in use, the first and second component are superimposed under pressure when folding the sheet of packing material (9), the first and second component spread into contact with each other.

17) A sheet of packing material as claimed in claim 15, wherein the first and second portion (27, 30) are so located that, in use, the first and second portion (27, 30) are superimposed to bring said first and second component into contact when folding the sheet of packing material (9).

18) A sheet of packing material as claimed in claim 14, wherein said first component comprises a substance selected from a group comprising:
a group of monomers, and
a catalyst for catalyzing polymerization of said monomers;
the second component being selected from a group comprising:
a group of monomers, and
a catalyst for catalyzing polymerization of said monomers;
on condition that: if the first component comprises the group of monomers, the second component comprises said catalyst; and, if the first component comprises the catalyst, the second component comprises said group of monomers.

19) A sheet of packing material as claimed in claim 18, wherein the monomers are selected and treated so as to be polymerizable for at least ten minutes after they are applied to the sheet of packing material.

20) A sheet of packing material as claimed in claim 18, wherein the monomers and the catalyst are selected and treated so that polymerization, i.e. activation of the bicomponent glue, is completed within forty seconds at ambient temperature.

21) A packet producible by means of a method as claimed in claim 1, and comprising a sheet of packing material (9); the packet (2) being characterized in that the sheet of packing material (9) comprises gummed portions (15, 16) of activated bicomponent glue.

22) A packet as claimed in claim 21, wherein the sheet of packing material is folded to define a folded wrapping (10); the gummed portions (15, 16) stabilizing the folded wrapping (10).
